(19) United States
(12) Patent Application Publication
(10) Pub. No.: US 2008/0183609 A1
(43) Pub. Date: Jul. 31, 2008

(54) Detecting Structuring of Financial Transactions

(75) Inventor: Peter J. Stretton, Hampshire (GB)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/060,925

(22) Filed: Apr. 2, 2008

Related U.S. Application Data
(63) Continuation of application No. 11/304,261, filed on Dec. 15, 2005.

(30) Foreign Application Priority Data
Jun. 26, 2003 (GB) 0314899.6
Dec. 19, 2003 (GB) PCT/GB2003/005567

(51) Int. Cl. G06Q 40/00

(52) U.S. Cl. 705/35

(57) ABSTRACT

A method of detecting structuring of financial transactions by instantiating an autonomous, intelligent, mobile agent (for example, an aglet) and attaching it to an onward wire transfer; gathering patterns of transfer activity at a recipient account wherein identities of parties to the transfer remain anonymous to the agent; and detecting aggregation among the patterns of transfer activity. The step of instantiating may be in response to a cash deposit passing a threshold test for suspicion. Detecting aggregation may identify inward transfers of amounts originally deposited as cash deposits less than a reporting requirement amount. Another agent may be interrogated to determine if more patterns of aggregation relate to a single receiving account. Details of the aggregation and an account association may be stored in a secure data container.

### CROSS-REFERENCE TO RELATED APPLICATIONS

This application is a Continuation of U.S. application Ser. No. 11/304,261 filed Dec. 15, 2005, the complete disclosure of which, in its entirety, is herein incorporated by reference.

### FIELD OF THE INVENTION

The present invention relates to the field of countering money laundering, and more specifically to the detection of money laundering by structuring of transactions and aggregation of money sums by wire transfer.

### BACKGROUND OF THE INVENTION

Money laundering represents a large and increasingly difficult to control problem within the finances of most nations today, and the trend appears to be for the scale of the problem to increase. One of the techniques commonly used in money laundering is to avoid the restrictions on cash transactions that require banks to report large cash deposits or movements by breaking the large cash amounts down into smaller amounts and depositing these smaller amounts in numerous accounts, later transferring the sums by wire transfers in order to aggregate the funds at a remote account. This is known as “structuring of transactions”.

In most countries having a sophisticated legal control structure in the financial arena, banks and other financial institutions have a duty to diligently attempt to detect indications of money laundering activity, such as structuring of transactions, and reporting them. However, they cannot accept an outside agency, such as another bank, or a government agency, having access to customer data because of their duty of confidentiality. Thus, when small (below the reporting limits—in the USA, $10,000) cash amounts are progressively aggregated by a number of wire transfers using a number of banks, each bank can only see the data that is in its own system. The overall pattern is not visible.

At the initial stage, any attempt to pattern match is rather inaccurate, giving too many false positives (mischaracterizations of activity as illicit when it is not) to be reliable—there may be a perfectly legitimate need for a small business to deposit amounts that approach, but never exceed, the reporting limit as a matter of course—a business might be stable and based on repeat business in which amounts between $8,500 and $9,500 are taken each week—the company might simply be taking rent for long-term lets of low-rental properties, and so the amounts may naturally vary little and be small. The real grounds for suspicion may only appear when several such small companies start to forward amounts into a single account (aggregation), and this might be by wire transfer to an account at a different bank. The first bank cannot see that aggregation taking place, as there will be confidentiality restrictions in place.

Present methods of detecting money-laundering activities rely largely on watch-lists of suspect individuals and nationalities, “know-your-customer” policies, and expensive large-scale data-mining in transaction record databases. This last gives only historical data, and may be too late to catch an ongoing activity, although it my yield evidence against an individual or organization.

A 1995 US government-commissioned study (U.S. Congress, Office of Technology Assessment, Information Technologies for Control of Money Laundering, OTA-ITC-630 (Washington, DC: U.S. Government Printing Office, September 1995) came to the conclusion that artificial intelligence (AI) could not be used to solve the problem of structured transaction detection because (a) it produced too many false positives, and (b) banks would not accept the potential exposure of customer data to other banks that would come about if AI methods were used on a supra-bank level high enough to reduce false positives sufficiently. The study also concluded that the burden of extra processing associated with known AI methods would be too great for the banks.

The applicant thus believes that it is desirable to have a method of detecting the structuring of transactions in a way that alleviates the above-referenced problems.

### SUMMARY OF THE INVENTION

The present invention accordingly provides, in a first aspect, a method of detecting structuring of financial transactions, comprising: instantiating a first agent that is autonomous, intelligent, and mobile; attaching said first agent to an onward transfer transaction; gathering, by said first agent, patterns of financial account transfer activity at a recipient account wherein identities of parties to said financial account transfer activity remain anonymous to said first agent; and detecting, by said first agent, a pattern of aggregation among said patterns of financial account transfer activity.

Preferably, said step of instantiating comprises instantiating in response to an indication that a cash deposit has passed a threshold test for suspicion.

Preferably, said step of detecting a pattern of aggregation comprises identifying a plurality of inward transfers of amounts originally deposited as cash deposits each less than a legal reporting requirement amount.

The method preferably further comprises the step of transmitting said first agent from a first computer system to a second computer system.

The method preferably further comprises the step of interrogating by said first agent a second agent to determine if two or more patterns of aggregation relate to a single receiving account.

The method preferably further comprises the step of cloning, by said first agent, to produce a second agent.

Preferably, said first and said second agents are aglets.

The method preferably further comprise the step of examining, by an agent, a watch list.

The method preferably further comprises the step of transmitting said second agent with stop orders for stopping an onward transfer transaction.

Preferably, said first agent acts within an environment that prevents said first agent from modifying system resources.

Preferably, said second agent acts within an environment that prevents said second agent from modifying system resources.

The method preferably further comprises the step of storing details of said pattern of aggregation and an account association therewith in a secure data container.

The method preferably further comprises the step of alerting a financial institution at which said step of detecting has been performed that said step of detecting has been performed.

In a second aspect, the present invention provides a computer program code element to, when loaded into a computer system and executed, perform the method of the first aspect.

features of the second aspect comprise program code elements corresponding to the method of the first aspect.

The invention advantageously provides a method for detecting transaction patterns that may be related to money laundering, even across numerous communicating bank systems, without allowing outside access to a bank's customer records until probable cause has been established and a subpoena or search warrant has been issued.

Further advantageously, the detecting program components can be small, agile pieces of code capable of pattern matching activity by detecting patterns in real time and within a local scope, rather than large AI programs that are pattern seeking over entire large databases.

As pointed out in the Government study, normal AI approaches produced too many false positives, and also banks would not accept the potential exposure of customer data to other banks that would come about if AI methods were used on a supra-bank level high enough to reduce false positives sufficiently.

One embodiments of the present invention advantageously address both of these problems by seeking more than only a small segment of a pattern of activity across a plurality of bank wire transfer interfaces that might be suspicious, thus having a wider view than any single bank can have. In this manner, the advantageous ability to reduce the number of false positives as the pattern progresses is provided—program components that find no evidence of suspect aggregation patterns after they have been sent a certain number of stages along a path of transfers can be programmed to simply deinstantiate themselves and delete any record of their existence from the secure environment. Because any extracted information that contains any customer data is preferably maintained inside a secure data container, no bank is able to see the data taken from another bank's records, and the information is only available to a law enforcement agency after finding probable cause and the issuing of a search warrant or subpoena.

### BRIEF DESCRIPTION OF THE DRAWINGS

One embodiment of the present invention will now be described, by way of example only, with reference to the accompanying drawings, in which:

FIG. 1 shows a structural view of a system in which aglets according to one embodiment of the present invention are operable to detect structuring of transactions;

FIG. 2 shows a method of detecting structuring of transactions according to one embodiment of the present invention; and

FIG. 3 shows further features of the method of detecting structuring of transactions according to one embodiment of the present invention.

### DETAILED DESCRIPTION OF THE ONE EMBODIMENT

In one embodiment of the present invention, an autonomous, intelligent, mobile software agent is used to detect patterns that may indicate structuring of transactions.

The one embodiment of the present invention uses autonomous, intelligent, mobile agents called “aglets” to trail transactions that have been “tagged” as stemming from possibly suspect starting points. Aglets are already well-known in the art, having been invented by researchers at the IBM Tokyo Research Laboratory, but a few notes on them and on their use will be found helpful, and will be included in the detailed description of the one embodiment of the present invention. The Aglet Software Developer's Kit (ASDK) is provided freely under an Open Source license and is available for download from the World Wide Web by software developers interested in using it. In brief, aglets are agent objects with defined sets of methods that enable them to behave in an autonomous fashion, in instantiating themselves in response to a particular “stimulus”, and then in serializing their program code and data in order to autonomously send themselves to remote systems. They are further capable of cloning themselves for various purposes, one of which is so that they can forward copies of themselves to remote systems.

To preserve the security and integrity of the systems on which aglets execute, they are capable of instantiating themselves only within a sealed-off aglet context, similar to the Java Virtual Machine “sandbox” which enables Java applets to operate within user's systems without having the ability to interact to the detriment of the “host” system. Similar security and integrity protection is provided in aglet contexts, thus preserving, in the one embodiment of the present invention, the confidentiality, security and integrity requirements of the banks in whose systems they will be executing.

In one embodiment, a pattern matching “sniffer” aglet is initiated at a first bank (financial institution) to examine cash transactions for patterns that might indicate that structuring of transactions is taking place. Alternatively, another pattern-matching application may perform the first pass, to save space in the aglet—in that case, the other pattern-matching application starts the smaller sniffer aglet. At this stage, the pattern match is rather inaccurate, giving too many false positives to be reliable—there may be a perfectly legitimate need for a small business to deposit amounts that approach, but never exceed, the reporting limit as a matter of course—a business might be stable and based on repeat business in which amounts between $8,500 and $9,500 are taken each week—the company might simply be taking rent for long-term lets of low-cost properties, and so the amounts may naturally vary little and be small. The real grounds for suspicion may only appear when several such small companies start to forward amounts into a single account (aggregation), and this might be by wire transfer to an account at a different bank (second financial institution). The first bank cannot see that aggregation taking place, as there will be confidentiality restrictions in place.

In one embodiment of present invention, the pattern matching aglet (a “sandboxed”, autonomous, intelligent mobile agent) transmits itself, with the wire transfer, from the first bank's system to the second and subsequent banks in the chain, holding a secure data container (possibly an IBM Cryptolope data container) with details of the original pattern, and seeking aggregation patterns associated with the second and subsequent transfers. As soon as it finds such a pattern of aggregation, it alerts the bank officials, who can then, if necessary, run their own automated and manual checks; the aglet also seeks other sniffer aglets in the same aglet environment and interrogates them as to the existence of any convergent tree structures. Any sniffer aglets that find such converging structures may then register with the bank officials the fact that they have found a tree structure of aggregation that joins the transactions they have been “tailing” at an aggregation node. The alerted bank can then follow its statutory reporting rules to inform the appropriate law enforcement organization that it suspects a money-laundering pattern and that it is holding an encrypted record of the transactions involved under the seal of the secure data container. The law enforcement agency then has “probable cause” and can obtain a subpoena to open the container to obtain the evidence. Meanwhile, if any onward transfers from a suspect account have taken place, the aglet or aglets may clone themselves and continue in pursuit, alerting subsequent banks to enable them to detect further activity and to report it. If the alert has reached the law enforcement agency, and they have confirmed the pattern match by examining the contents of the secure data container, the sniffer aglet at the bank that holds the secure data container may be cloned under control of the law enforcement agency and may be sent to trail its “sent ahead” clone, or clones, with powers to issue instructions to stop further transactions under penalty of law, and to report back, with a log of the or each journey, so that the onward trail may be used by the agency. At any point of divergence, the sniffer aglet that has been sent onward can clone itself to follow more than one path, leaving a “forwarding address” inside the secure aglet environment, so that it can be followed.

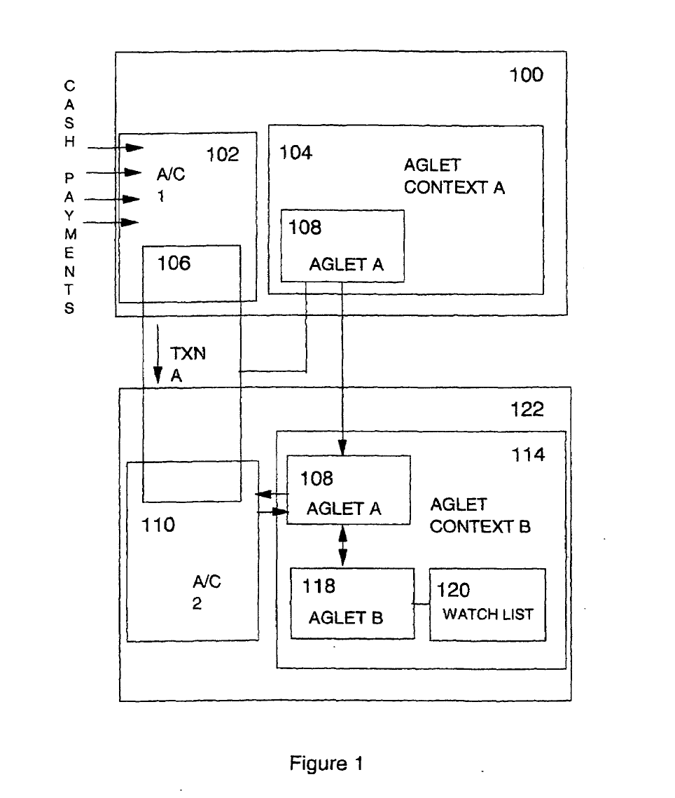

Referring now to FIG. 1, there is shown a first computer system (100) operable to receive cash payments into account A/C 1 (102). When Aglet A (108) receives an initialization signal, which may be because a further pattern matching program (not shown here) has recognized a suspicious pattern, a name on a watch list, or the like and has issued a signal to instantiate the aglet. In one alternative, an aglet may be signaled to instantiate in response to every cash payment in a particular category, for example, within a margin deemed to be close to the reporting limit.

Transfer transaction TXN A (106) causes the associated Aglet A (108) to follow it by serializing itself in a conventional manner, transmitting itself to the destination system of TXN A (106). Thus Aglet A (108) moves from aglet context A (104) in first computer system (100) into aglet context B (114) in second computer system (122) and reinstantiates itself. Systems 100 and 122 may be within a single institution's computer system infrastructure, or may be in separate institutions connected by a financial clearing network, or by some more general network, of which one example is the Internet.

Aglet A (108) is equipped to check activity patterns within account A/C 2 (110) in an attempt to either confirm a positive match with a suspect pattern, or to eliminate suspicion. If it eliminates suspicion, it simply clears away all its data and destroys itself. Aglet A (108) can also communicate with any other aglets within aglet contexts (104, 108). Here, Aglet A (108) communicates with Aglet B (118). Aglets, such as (108, 118) can also use watch list (120) as part of the process of confirming or eliminating suspicion.

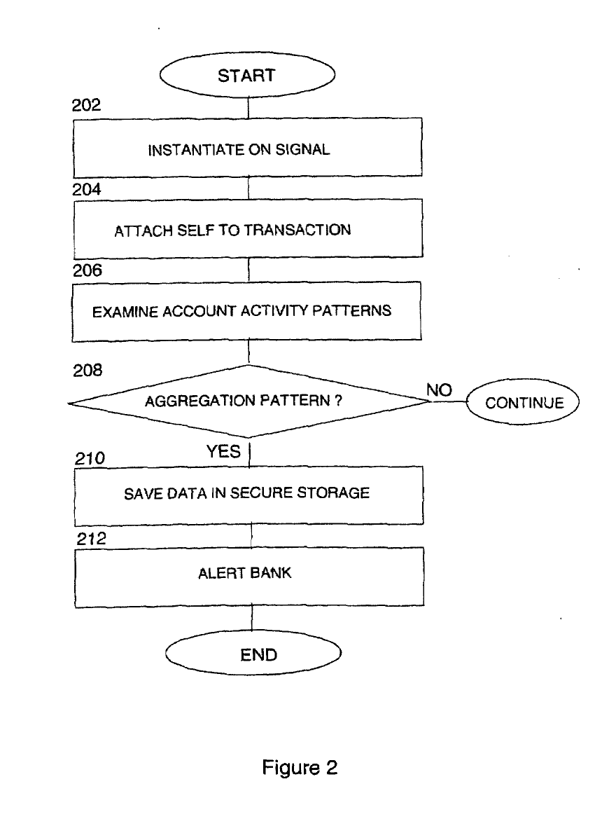

Turning now to FIG. 2, at step 202 an aglet instantiates itself on a signal, as described above. At step 204, the aglet attaches itself to a transaction, and at step 206, it examines account activity patterns. This is preferably done by asking the aglet context to return pattern information, which can be analyzed by the pattern matching code of the aglet. If the aglet finds an aggregation pattern at step 208 indicating that suspicion has been confirmed to a certain threshold level of probability, it saves data in some form of secured storage at step 210 and alerts the bank at step 212.

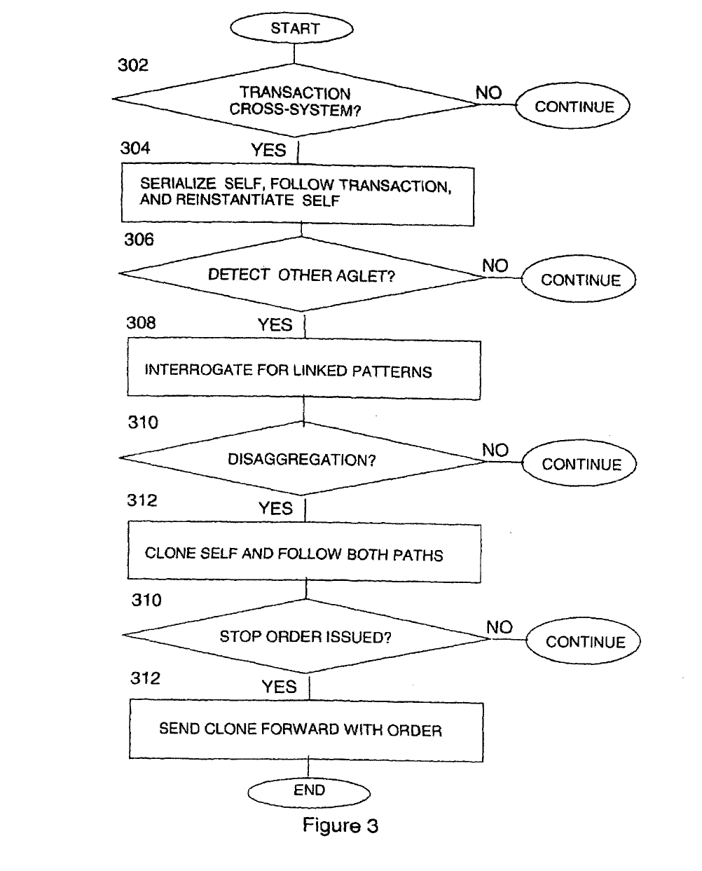

In FIG. 3 are shown some further tests and responsive actions that are elements of the one embodiment. First, at step 302 the aglet checks for transactions that cross system boundaries. If such is detected, the aglet at step 304 serializes itself, follows the transaction to the new system, and reinstantiates itself there. If an aglet detects another aglet at step 306, it interrogates the other aglet for linked patterns at step 308. Thus do aglets collaborate to identify patterns indicating aggregations indicative of money laundering by means of structuring of transactions. If, at step 310, an action of disaggregation is detected (that is, two amounts are transferred from an account under observation out to two or more separate recipient accounts) the aglet clones itself and thus both transactions have a copy of the aglet associated with, and “traveling with” them. If it is detected at step 310 that a control agency has issued a stop order to prevent further transactions in a sequence, the aglet is operable at step 312 to clone itself and send its clone forward in pursuit of onward transactions until it reaches a transaction that is still in-flight (started, but not yet committed) and thus can be stopped before completion.

The aglet and the infrastructure in which it “lives” in each system may need to form part of a trust structure, to permit aglets to pass from system to system without compromising the security of the systems. They may need to be capable of tunneling through firewalls, and for this to be acceptable to banks, each aglet environment will need a sophisticated security arrangement. However, the aglet of the one embodiment itself cannot “see” customer data, which is retrieved via the aglet environment and placed directly into a secure data container—the aglet can only read and match anonymous patterns and carry the secure data container, not read its contents. The aglet, once it is in its context in a bank's system, is really engaged in detecting aggregation nodes, and listening for any other sniffer aglets that may have located the same aggregation account from a different suspect starting account. It is not concerned with customer account details, but only with a limited set of indicator patterns, which may be retrieved by the aglet context, rather than by allowing the aglet any access to customer account data.

One embodiment of the present invention provides the sniffer aglets with sets of patterns to detect, first, potentially suspect cash transactions, and then patterns of converging transactions as amounts are aggregated. Aglets known in the art are already provided with means to communicate with other aglets, so it is straightforward to provide “rules of engagement” to allow two sniffer aglets to “join forces”. Aglets also have the power to clone themselves, making them very suitable to follow diverging paths of transfers, as well as converging paths.

In one embodiment, an aglet environment is constructed with the capability of accepting secure, trusted aglets and permitting them to await the triggering of a transaction event that can be tested against the suspect pattern templates with which they are provided. The aglets are programmed, for example to test for patterns of aggregation of small amounts into larger amounts by transfer of funds by wire from what was originally a suspected transaction structuring account. The aglet carries with it a first secure data container containing data gathered during the original alerting process at the bank where the aglet was initiated. The aglet also queries the aglet environment for the existence of other aglets, so that the aglets can combine forces if they discover that both are triggered by pattern-matched events on the same account. The aglets may further be equipped with the capability of triggering the aglet context to examine account names, destinations etc. for any that are on the watch list (Suspect Territory account holders, Suspect Persons lists, etc.). The aglet may not need to carry these lists with it, as they will already be stored somewhere in the bank's system, and thus will be accessible by the aglet environment on the system. The aglet may then alert the aglet environment, which creates a secure data container into which all transaction data that is already stored in the first secure data container, and any further data gathered at this bank can be stored. If the probability of a false positive is determined to be low, the aglet requests the aglet environment to alert the bank. If there is an onward transfer of funds the aglet clones itself and sends its clone onward with the transfer.

It will be appreciated that the method described above will typically be carried out in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will be appreciated that various modifications to the embodiment described above will be apparent to a person of ordinary skill in the art.

1. A method of detecting structuring of financial transactions, comprising:
instantiating a first agent;
attaching said first agent to an onward transfer transaction;
gathering, by said first agent, patterns of financial account transfer activity at a recipient account wherein identities of parties to said financial account transfer activity remain anonymous to said first agent; and
detecting, by said first agent, a pattern of aggregation among said patterns of financial account transfer activity.

2. A method as claimed in claim 1, all the limitations of which are incorporated herein by reference, wherein said detecting of said pattern of aggregation comprises identifying a plurality of inward transfers of amounts originally deposited as cash deposits, each less than a legal reporting requirement amount.

3. A method as claimed in claim 1, all the limitations of which are incorporated herein by reference, further comprising transmitting said first agent from a first computer system to a second computer system.

4. A method as claimed claim 1, all the limitations of which are incorporated herein by reference, further comprising interrogating, by said first agent, a second agent to determine if two or more patterns of aggregation relate to a single receiving account.

5. A method as claimed claim 1, all the limitations of which are incorporated herein by reference, wherein said first agent comprises an aglet.

6. A method as claimed in claim 1, all the limitations of which are incorporated herein by reference, further comprising transmitting a second agent with stop orders for stopping said onward transfer transaction.

7. A method as claimed in claim 1, all the limitations of which are incorporated herein by reference, wherein said first agent acts within an environment that prevents said first agent from modifying system resources.

8. A method as claimed in claim 1, all the limitations of which are incorporated herein by reference, further comprising storing details of said pattern of aggregation and an account association therewith in a secure data container.

9. A method as claimed in claim 1, all the limitations of which are incorporated herein by reference, further comprising alerting a financial institution at which said detecting and storing have been performed that said detecting and storing have been performed.

10. A computer program product tangibly embodied in a computer-readable medium to, when loaded into a computer system and executed, cause said computer system to perform the computer program comprising a method of:
instantiating a first agent that is autonomous, intelligent, and mobile;
attaching said first agent to an onward transfer transaction;
gathering, by said first agent, patterns of financial account transfer activity at a recipient account wherein identities of parties to said financial account transfer activity remain anonymous to said first agent; and
detecting, by said first agent, a pattern of aggregation among said patterns of financial account transfer activity.

11. A method of detecting structuring of financial transactions, comprising:
instantiating a first agent at a first financial institution;
attaching said first agent to an onward transfer transaction;
gathering, by said first agent, patterns of financial account transfer activity through at least one second financial institution at a recipient account wherein identities of parties to said financial account transfer activity remain anonymous to said first agent; and
detecting, by said first agent, a pattern of aggregation among said patterns of financial account transfer activity.

12. A method as claimed in claim 11, all the limitations of which are incorporated herein by reference, wherein said detecting of said pattern of aggregation comprises identifying a plurality of inward transfers of amounts originally deposited as cash deposits, each less than a legal reporting requirement amount.

13. A method as claimed in claim 11, all the limitations of which are incorporated herein by reference, further comprising transmitting said first agent from a first computer system to a second computer system.

14. A method as claimed claim 11, all the limitations of which are incorporated herein by reference, further comprising interrogating, by said first agent, a second agent to determine if two or more patterns of aggregation relate to a single receiving account.

15. A method as claimed claim 11, all the limitations of which are incorporated herein by reference, wherein said first agent comprises an aglet.

16. A method as claimed in claim 11, all the limitations of which are incorporated herein by reference, further comprising transmitting a second agent with stop orders for stopping said onward transfer transaction.

17. A method as claimed in claim 11, all the limitations of which are incorporated herein by reference, wherein said first agent acts within an environment that prevents said first agent from modifying system resources.

18. A method as claimed in claim 11, all the limitations of which are incorporated herein by reference, further comprising storing details of said pattern of aggregation and an account association therewith in a secure data container.

19. A method as claimed in claim 11, all the limitations of which are incorporated herein by reference, further comprising alerting a financial institution at which said detecting and storing have been performed that said detecting and storing have been performed.
